(19) United States
(12) Patent Application Publication
(10) Pub. No.: US 2020/0074527 A1
(43) Pub. Date: Mar. 5, 2020

(54) Method for Online Investigation Order for Immediate Performance

(71) Applicants: Anton Edelman, Netania (IL); Tsah Ezekiel, Oranit (IL)

(72) Inventors: Anton Edelman, Netania (IL); Tsah Ezekiel, Oranit (IL)

(21) Appl. No.: 16/120,901

(22) Filed: Sep. 4, 2018

(51) Int. Cl. G06Q 30/06

(52) U.S. Cl. CPC G06Q 30/0633; H04L 67/10

(57) ABSTRACT

A method for online investigation orders that enables a user of an internet device to sign up as a client or as a provider and to open an account. The method enables the client to create an online investigation order, which specify the target, the required information and documentation, and the location at which the target is likely to be at a specified time. The method enables the provider to specify an area of activity in which he agrees to provide investigation services according to online investigation orders. The method detects the location of the provider in real-time, identifies the location in which online investigation orders are required to be performed, and sends the orders to the provider according to his area of activity. The method also enable the provider to send blurred images to the client for assessment and for negotiating a price for the images.

### TECHNICAL FIELD

The present invention refers to a method for online investigation order for immediate performance.

### BACKGROUND ART

In many situations a person may need immediate performance of a private investigation service regarding a specific target. The specific target may be a person, a pet, a place, an object and the like. The investigation service may include finding and locating the target, following it and documenting its actions or situations. When the target is a person the investigation may include finding and locating the person and filming or photographing his or her actions, and providing a report to the person who made the order. When the target is a lost pet or a person the investigation may include finding the target and informing the person who made the order that the target has been found. When the target is a place the investigation may include arriving to the place and filming or photographing the place at that time, and sending to the person who made the order the report as to the situation of that place at that moment. The present invention offers an effective solution for these needs by providing a method that is in fact a web platform that serves as a platform for ordering online in real time an investigation tasks as to a specific target.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a block diagram that illustrates two internet devices (200), of a provider and a client, each of them includes a processing device (10) and a server (100) with a processing device (10).

### THE INVENTION

The main object of the present patent application is to provide a method performed by processing device (10) that is designed to enable a user of internet device (200) to create an online investigation order for immediate performance.

The term “internet device” (200) in the present patent application and in the claims refers to any kind of device which is designed to have internet connection, such as smartphones, computers, tablets and the like.

The term “investigation” in this patent application and in the claims refers to all those kinds of services as stated in the background of the application that may include finding, locating, documenting, filming, photographing, and any other kind of surveillance activities.

The word “immediate” in the term “immediate performance” in this patent application and in the claims refers to a period of time that begins immediately and up to 24 hours.

A web platform such as a computer program may be used as a framework for the overall operation and use of the method and for the sake of fluency we will use the terms “web platform” and “method” hereinafter in this connection and as having in general the same meaning. A user of an internet device (200) may download the web platform which is performed by the processing device (10) of the internet device (200), and may be also performed by a processing device in a server (100).

The method for online investigation orders for immediate performance performed by a processing device running on an internet device, may include the following steps and features:

(a) The method enables a user of the internet device to sign-up as a client or to sign-up as a provider.

(b) The method enables the user to open an account and to be identified by his or her user account.

(c) The method enables a client to create an online investigation order, to specify the specific target of said online investigation order and the information and documentation required by the client regarding that specific target.

(d) The method enables the client to specify in said online investigation order a location at which the specific target is likely to be at a specified time. The client may specify in his order that the specific target is now or going to be at a specified time in a specific address or specific location. Thus, the providers may have information when and where to start the investigation.

(e) The method enables the client to attach files to the online investigation order, such as media files that may include photos, video, audio files and etc., that may includes information about the specific target, for assisting the provider to perform the order properly and efficiently.

(f) The method enables the client to specify in his online investigation order a timeframe in which the online investigation order should be performed and/or reported. By that, the method enables the client to specify the level of urgency in terms of time to perform the online investigation order. The client may specify that he or she wants that said performance should be done immediately or within specific certain of time.

(g) The method enables the provider to specify an area of activity in which he or she agrees to provide investigation services according to online investigation orders. This area of activity may be a permanent area or additionally or alternatively an area based on the provider current location plus predetermined radius. The term “current location” in this connection means the place in which the provider is located when the order is received.

For example: (1) the provider may specify a specific city or county and the like as his or her area of activity; (2) the provider may specify his or her office or home plus specific radius as his or her area of activity; (3) the provider may specify his or her current location plus certain radios as the area of activity (this in addition or alternatively to an area of activity based on a permanent address).

The method also enables the provider to expand or narrow the area of activity based on the level of urgency in terms of time to perform the online investigation order. For example, the provider may set his or her area of activity as his or her current location plus radius of 3 kilometers when the client needs an immediate performance within 30 minutes, plus radius of 10 kilometers when the client needs the performance within One hour, and plus radius of 25 kilometers when the client needs the performance within 2 hours.

(h) The method enables the provider to specify that he or she prefer to receive online investigation orders that are required to be performed within his or her area of activity.

(i) The method detects the locations of providers in real-time. The method may constantly or each period of time detects the locations of the providers when the method is switched on their internet device.

(j) The method identifies the territory in which the online investigation order is required to be performed.

(k) The method sends online investigation orders to providers according to their area of activity or as calculated according to the level of urgency in terms of time to perform said online investigation orders.

(l) The method enables the provider and the client to communicate regarding the performance of the online investigation order.

As stated above, the method enables the client to specify in his or her online investigation order the required information or documentation. For example, the client may ask for: a photo of a specific person that is now sitting in café and that the photo should include all the people who are sitting with him around the table (in cases of a jealous wife that wants to be sure that her husband is not associating with women more attractive than her); information and photos of a person from the moment that he goes outside his office at a specific address at 16:00 until 18:00 including photos with all the people that he met in these two hours (in cases of person that wish to know what other person done in these specific two hours); a photo of a door of a certain restaurant that is located at specific address now or at a certain time (in cases when the owner wishes to know whether his employees opened the restaurant at time); to find or locate a pet or a person (in case that the pet or person was lost in a specific park).

(m) The method enables the client to add to his or her online investigation order a price that he or she agrees to pay for said required information or documentation or to add an invitation to receive quotes from providers for said required information or documentation.

(n) The method may associate built-inn or external software for blurring images for enabling the provider to blur images; the method enables the provider to send the blurred images to the client for assessment and for negotiating the price for the original un-blurred images.

(o) The method enables the client and the provider to agree as to the price for said required information or documentation, and to document said price and said required information or documentation.

(p) The method enables the client to pay on-condition the agreed price to account of the operator of the method.

The payment on-condition can be done by credit card or any other known methods of online payments. When the provider sends to the client the required information or documentation then the client approve the payment and the payment is transferred to the provider, that in turns transfer the payment or part of it to the operator. In case of disagreement whether the information or documentation that the provider has sent to the client fulfilled the required information or documentation and/or that this information or documentation has been sent on time, the operator may serve as a decisive arbitrator between the client and the provider.

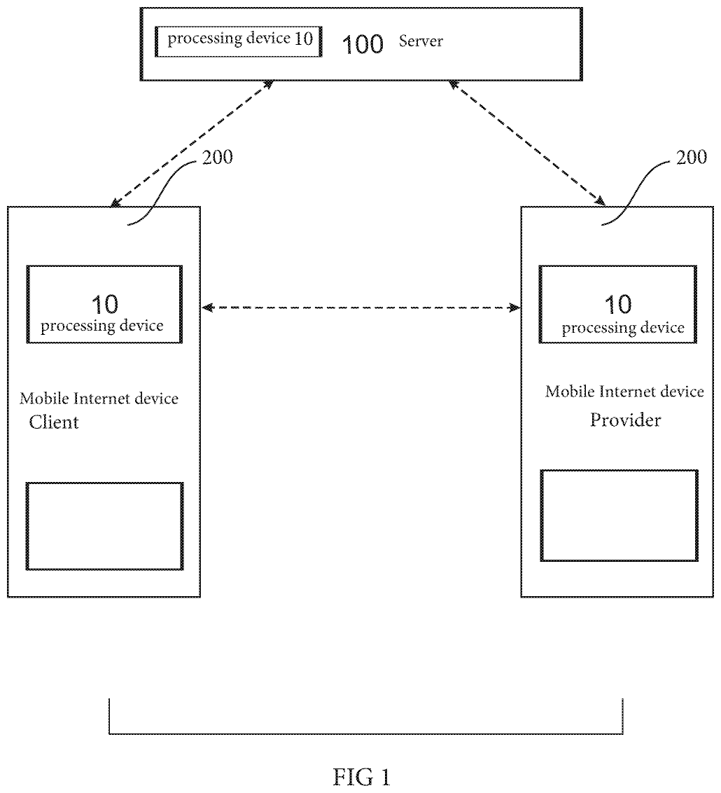

FIG. 1 is a block diagram that illustrates two internet devices (200), of a provider and a client, each of them includes a processing device (10) and a server (100) with a processing device (10).

What is claimed is:

1. A method for online investigation orders performed by a processing device running on an internet device, comprising:
(a) enabling a user of the internet device to sign up as a client or as a provider;
(b) enabling the user to open an account and to be identified by his or her user account;
(c) enabling the client to create an online investigation order, to specify the specific target of said online investigation order and information and documentation required by the client regarding that specific target;
(d) enabling the client to specify in said online investigation order a location at which the specific target is likely to be at a specified time;
(e) enabling the client to attach files to the online investigation order;
(f) enabling the client to specify a timeframe in which the online investigation order should be performed and reported;
(g) enabling the provider to specify an area of activity in which he or she agrees to provide investigation services according to online investigation orders;
(h) enabling the provider to specify that he or she prefer to receive online investigation orders that are required to be performed within his or her area of activity;
(i) detecting a location of said provider in real-time;
(j) identifying the location in which said online investigation order is required to be performed;
(k) sending said online investigation order to the provider according to his or her area of activity;
(l) enabling the provider and the client to communicate regarding performance of said online investigation order; and
(m) enabling the client to add to his or her online investigation order a price that he or she agrees to pay for said required information or documentation or to add an invitation to receive quotes from providers of said method for said required information or documentation;

2. The method for online investigation orders performed by a processing device running on an internet device according to claim 1 that further comprising:
associating built-inn or external software for blurring images that enables said providers of said method to blur images; and
enabling said providers to send said blurred images to said client for assessment and for negotiating a price for said images.
